(19) United States
(12) Patent Application Publication
(10) Pub. No.: US 2022/0138896 A1
(43) Pub. Date: May 5, 2022

(54) SYSTEMS AND METHODS FOR POSITIONING

(71) Applicant: BEIJING VOYAGER TECHNOLOGY CO., LTD., Beijing (CN)

(72) Inventors: Tingbo HOU, Mountain View, CA (US); Xiaozhi QU, Beijing (CN)

(73) Assignee: BEIJING VOYAGER TECHNOLOGY CO., LTD., Beijing (CN)

(21) Appl. No.: 17/647,734

(22) Filed: Jan. 11, 2022

Related U.S. Application Data
(63) Continuation of application No. PCT/CN2019/095816, filed on Jul. 12, 2019.

(51) Int. Cl. G06T 3/00; G06T 7/30; G06T 3/40

(52) U.S. Cl. CPC G06T 3/0068; G06T 7/30; G06T 2207/20021; G06T 2207/10028; G06T 3/4007

(57) ABSTRACT

The present disclosure relates to positioning systems and methods. A system may obtain point-cloud data acquired by one or more sensors associated with a subject during a time period. The point-cloud data may be associated with an initial position of the subject. The system may also divide the point-cloud data into a plurality of groups. The system may also obtain pose data of the subject corresponding to each group of the plurality of groups of the point-cloud data. The system may also register, based on the pose data of the subject, the each group of the plurality of groups of the point-cloud data to form registered point-cloud data. The system may also generate, based on the registered point-cloud data, a local map associated with the initial position of the subject.

### CROSS-REFERENCE TO RELATED APPLICATIONS

The application is a continuation of International Application No. PCT/CN2019/095816, filed on Jul. 12, 2019, the contents of which are hereby incorporated by reference.

### TECHNICAL FIELD

The present disclosure generally relates to systems and methods for positioning technology, and specifically, to systems and methods for generating a local map based on point-cloud data during a time period.

### BACKGROUND

Positioning techniques are widely used in various fields, such as an autonomous driving system. For the autonomous driving system, it is important to determine a precise location of a subject (e.g., an autonomous vehicle) in a pre-built map (e.g., a High-definition map) during driving of the autonomous vehicle. The positioning techniques may be used to determine an accurate location of the autonomous vehicle by matching a local map generated by scanning data (e.g., point-cloud data) acquired by one or more sensors (e.g., a LiDAR) installed on the autonomous vehicle with the pre-built map. Precision positioning of the subject relies on accurate matching of the local map with the pre-built map. However, the point-cloud data scanned by the LiDAR in real-time includes sparse points and less information of the environment, which results in a difficulty to directly match the HD map of the environment. Thus, it is desirable to provide systems and methods for generating the HD map (also referred to as a local map) for positioning the vehicle in real-time more accurately.

### SUMMARY

According to one aspect of the present disclosure, a positioning system is provided. The system may include at least one storage medium including a set of instructions, and at least one processor in communication with the at least one storage medium. When executing the set of instructions, the at least one processor may perform the following operations. The at least one processor may obtain point-cloud data acquired by one or more sensors associated with a subject during a time period, the point-cloud data being associated with an initial position of the subject. The at least one processor may also divide the point-cloud data into a plurality of groups. The at least one processor may also obtain pose data of the subject corresponding to each group of the plurality of groups of the point-cloud data. The at least one processor may also register, based on the pose data of the subject, the each group of the plurality of groups of the point-cloud data to form registered point-cloud data. The at least one processor may also generate, based on the registered point-cloud data, a local map associated with the initial position of the subject.

In some embodiments, the each group of the plurality of groups may correspond to a time stamp. To obtain the pose data of the subject corresponding to the each group of the plurality of groups of the point-cloud data, the at least one processor may determine, based on the time stamp, the pose data of the subject corresponding to the each group of the plurality of groups of the point-cloud data.

In some embodiments, to obtain the pose data of the subject corresponding to the each group of the plurality of groups of the point-cloud data, the at least one processor may obtain a plurality of first groups of pose data of the subject during the time period. The at least one processor may also perform an interpolation operation on the plurality of first groups of pose data of the subject to generate a plurality of second groups of pose data. The at least one processor may also determine, from the plurality of second groups of pose data, the pose data of the subject corresponding to the each group of the plurality of groups of the point-cloud data.

In some embodiments, the at least one processor may perform the interpolation operation on the plurality of first groups of pose data to generate the plurality of second groups of pose data using a spherical linear interpolation technique.

In some embodiments, to register, based on the pose data of the subject, the each group of the plurality of groups of the point-cloud data to form the registered point-cloud data, the at least one processor may transform, based on the pose data of the subject, the each group of the plurality of groups of the point-cloud data in a first coordinate system associated with the subject into a second coordinate system.

In some embodiments, to transform, based on the pose data of the subject, the each group of the plurality of groups of the point-cloud data from the first coordinate system associated with the subject into the second coordinate system, the at least one processor may determine, based on the pose data of the subject corresponding to the each group of the plurality of groups of the point-cloud data, one or more transform models. The at least one processor may also transform, based on the one or more transform models, the each group of the plurality of groups of the point-cloud data from the first coordinate system into the second coordinate system.

In some embodiments, the one or more transform models may include at least one of a translation transformation model or a rotation transformation model.

In some embodiments, to generate, based on the registered point-cloud data, a local map associated with the initial position of the subject, the at least one processor may generate the local map by projecting the registered point-cloud data on a plane in a third coordinate system.

In some embodiments, to generate the local map by projecting the registered point-cloud data on a plane in a third coordinate system, the at least one processor may generate a grid in the third coordinate system in which the initial position of the subject is a center, the grid including a plurality of cells. The at least one processor may also generate the local map by mapping feature data in the registered point-cloud data into one or more corresponding cells of the plurality of cells.

In some embodiments, the feature data may include at least one of intensity information or elevation information received by the one or more sensors.

In some embodiments, the at least one processor may further generate, based on incremental point-cloud data, the local map.

In some embodiments, the at least one processor may further update, based on feature data in the incremental point-cloud data, at least one portion of the plurality of cells corresponding to the incremental point-cloud data.

According to another aspect of the present disclosure, a positioning method is provided. The method may include obtaining point-cloud data acquired by one or more sensors associated with a subject during a time period, the point-cloud data being associated with an initial position of the subject. The method may also include dividing the point-cloud data into a plurality of groups. The method may also include obtaining pose data of the subject corresponding to each group of the plurality of groups of the point-cloud data. The method may also include registering, based on the pose data of the subject, the each group of the plurality of groups of the point-cloud data to form registered point-cloud data. The method may also include generating, based on the registered point-cloud data, a local map associated with the initial position of the subject.

According to another aspect of the present disclosure, a non-transitory computer readable medium, comprising at least one set of instructions compatible for positioning, is provided. When executed by at least one processor of an electrical device, the at least one set of instructions may direct the at least one processor to perform the following operations. The at least one processor may obtain point-cloud data acquired by one or more sensors associated with a subject during a time period, the point-cloud data being associated with an initial position of the subject. The at least one processor may also divide the point-cloud data into a plurality of groups. The at least one processor may also obtain pose data of the subject corresponding to each group of the plurality of groups of the point-cloud data. The at least one processor may also register, based on the pose data of the subject, the each group of the plurality of groups of the point-cloud data to form registered point-cloud data. The at least one processor may also generate, based on the registered point-cloud data, a local map associated with the initial position of the subject.

According to another aspect of the present disclosure, a positioning system is provided. The system may include an obtaining module, a registering module, and a generating module. The obtaining module may be configured to obtain point-cloud data acquired by one or more sensors associated with a subject during a time period. The point-cloud data being associated with an initial position of the subject. The obtaining module may also be configured to divide the point-cloud data into a plurality of groups. obtaining module may also be configured to obtain pose data of the subject corresponding to each group of the plurality of groups of the point-cloud data. The registering module may be configured to register, based on the pose data of the subject, the each group of the plurality of groups of the point-cloud data to form registered point-cloud data. The generating module may be configured to generate, based on the registered point-cloud data, a local map associated with the initial position of the subject.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary autonomous driving system according to some embodiments of the present disclosure;

FIG. 2 is a schematic diagram illustrating exemplary hardware and software components of a computing device according to some embodiments of the present disclosure;

FIG. 3 is a schematic diagram illustrating exemplary hardware and/or software components of a mobile device according to some embodiments of the present disclosure;

FIG. 4A is a block diagram illustrating exemplary processing engine according to some embodiments of the present disclosure;

FIG. 4B is a block diagram illustrating an exemplary obtaining module according to some embodiments of the present disclosure;

FIG. 5 is a flowchart illustrating an exemplary process for generating a local map associated with a subject according to some embodiments of the present disclosure;

FIG. 6 is a flowchart illustrating an exemplary process for obtaining pose data of a subject corresponding to each group of a plurality of groups of point cloud data according to some embodiments of the present disclosure; and

FIG. 7 is a flowchart illustrating an exemplary process for generating a local map associated with a subject according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” “module,” and/or “block” used herein are one method to distinguish different components, elements, parts, section or assembly of different level in ascending order. However, the terms may be displaced by another expression if they achieve the same purpose.

Generally, the word “module,” “unit,” or “block,” as used herein, refers to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in a firmware, such as an erasable programmable read-only memory (EPROM). It will be further appreciated that hardware modules/units/blocks may be included in connected logic components, such as gates and flip-flops, and/or can be included of programmable units, such as programmable gate arrays or processors. The modules/units/blocks or computing device functionality described herein may be implemented as software modules/units/blocks, but may be represented in hardware or firmware. In general, the modules/units/blocks described herein refer to logical modules/units/blocks that may be combined with other modules/units/blocks or divided into sub-modules/sub-units/sub-blocks despite their physical organization or storage. The description may be applicable to a system, an engine, or a portion thereof.

It will be understood that when a unit, engine, module or block is referred to as being “on,” “connected to,” or “coupled to,” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

An aspect of the present disclosure relates to positioning systems and methods for generating a local map associated with a vehicle. To this end, the systems and methods may obtain point-cloud data associated with an initial position of the subject during a time period from one or more sensors (e.g., a LiDAR, a Global Positioning System (GPS) receiver, one or more (Inertial Measurement Unit) IMU sensors) associated with the vehicle. The point-cloud data may include a plurality of groups corresponding to a time stamp. The systems and methods may determine pose data of the vehicle for each group of the plurality of groups. The systems and methods may also transform the point-cloud data of each group into a same coordinate system based on the pose data of the vehicle to obtain transformed point-cloud data. The systems and methods may further generate the local map associated with the vehicle by projecting the transformed point-cloud data on a plane. In this way, the systems and methods of the present disclosure may help to position and navigate the vehicle more efficiently and accurately.

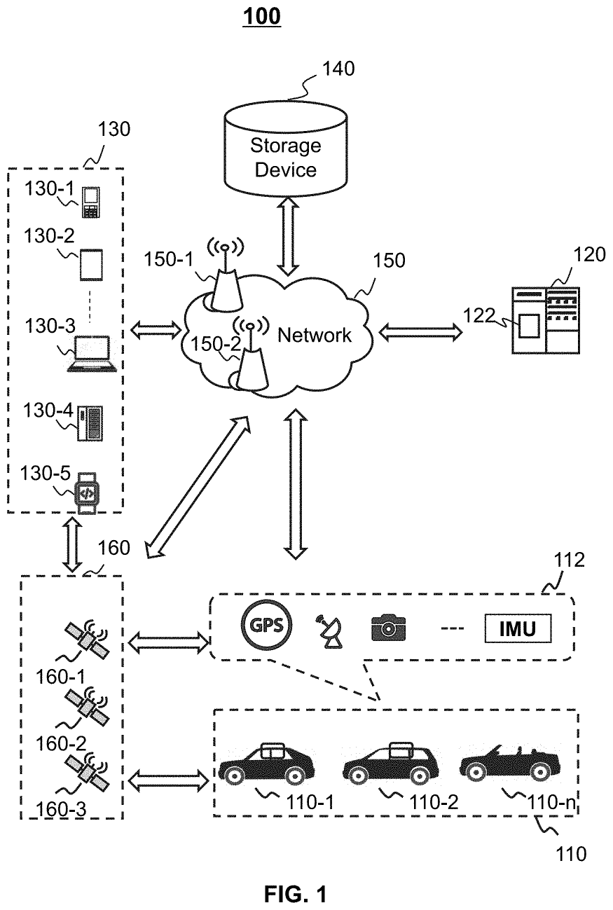

FIG. 1 is a block diagram illustrating an exemplary autonomous driving system according to some embodiments of the present disclosure. For example, the autonomous driving system 100 may provide a plurality of services such as positioning and navigation. In some embodiments, the autonomous driving system 100 may be applied to different autonomous or partially autonomous systems including but not limited to autonomous vehicles, advanced driver assistance systems, robots, intelligent wheelchairs, or the like, or any combination thereof. In a partially autonomous system, some functions can optionally be manually controlled (e.g., by an operator) some or all of the time. Further, a partially autonomous system can be configured to switch between a fully manual operation mode and a partially-autonomous and/or a fully-autonomous operation mode. The autonomous or partially autonomous system may be configured to operate for transportation, operate for map data acquisition, or operate for sending and/or receiving an express. For illustration, FIG. 1 takes autonomous vehicles for transportation as an example. As shown in FIG. 1, the autonomous driving system 100 may include one or more vehicle(s) 110, a server 120, one or more terminal device(s) 130, a storage device 140, a network 150, and a positioning and navigation system 160.

The vehicle(s) 110 may carry a passenger and travel to a destination. The vehicle(s) 110 may include a plurality of vehicle(s) 110-1, 110-2 . . . 110-n. In some embodiments, the vehicle(s) 110 may be any type of autonomous vehicles. An autonomous vehicle may be capable of sensing its environment and navigating without human maneuvering. In some embodiments, the vehicle(s) 110 may include structures of a conventional vehicle, for example, a chassis, a suspension, a steering device (e.g., a steering wheel), a brake device (e.g., a brake pedal), an accelerator, etc. In some embodiments, the vehicle(s) 110 may be a survey vehicle configured for acquiring data for constructing a high-definition map or 3-D city modeling (e.g., a reference map as described elsewhere in the present disclosure). It is contemplated that vehicle(s) 110 may be an electric vehicle, a fuel cell vehicle, a hybrid vehicle, a conventional internal combustion engine vehicle, etc. The vehicle(s) 110 may have a body and at least one wheel. The body may be any body style, such as a sports vehicle, a coupe, a sedan, a pick-up truck, a station wagon, a sports utility vehicle (SUV), a minivan, or a conversion van. In some embodiments, the vehicle(s) 110 may include a pair of front wheels and a pair of rear wheels. However, it is contemplated that the vehicle(s) 110 may have more or less wheels or equivalent structures that enable the vehicle(s) 110 to move around. The vehicle(s) 110 may be configured to be all wheel drive (AWD), front wheel drive (FWR), or rear wheel drive (RWD). In some embodiments, the vehicle(s) 110 may be configured to be operated by an operator occupying the vehicle, remotely controlled, and/or autonomous.

As illustrated in FIG. 1, the vehicle(s) 110 may be equipped with a plurality of sensors 112 mounted to the body of the vehicle(s) 110 via a mounting structure. The mounting structure may be an electro-mechanical device installed or otherwise attached to the body of the vehicle(s) 110. In some embodiments, the mounting structure may use screws, adhesives, or another mounting mechanism. The vehicle(s) 110 may be additionally equipped with the sensors 112 inside or outside the body using any suitable mounting mechanisms.

The sensors 112 may include a camera, a radar unit, a GPS device, an inertial measurement unit (IMU) sensor, a light detection and ranging (LiDAR), or the like, or any combination thereof. The Radar unit may represent a system that utilizes radio signals to sense objects within the local environment of the vehicle(s) 110. In some embodiments, in addition to sensing the objects, the Radar unit may additionally be configured to sense the speed and/or heading of the objects. The camera may include one or more devices configured to capture a plurality of images of the environment surrounding the vehicle(s) 110. The camera may be a still camera or a video camera. The GPS device may refer to a device that is capable of receiving geolocation and time information from GPS satellites and then to calculate the device's geographical position. The IMU sensor may refer to an electronic device that measures and provides a vehicle's specific force, angular rate, and sometimes the magnetic field surrounding the vehicle, using various inertial sensors, such as accelerometers and gyroscopes, sometimes also magnetometers. The IMU sensor may be configured to sense position and orientation changes of the vehicle(s) 110 based on various inertial sensors. By combining the GPS device and the IMU sensor, the sensor 112 can provide real-time pose information of the vehicle(s) 110 as it travels, including the positions and orientations (e.g., Euler angles) of the vehicle(s) 110 at each time point. The LiDAR may be configured to scan the surrounding and generate point-cloud data. The LiDAR may measure a distance to an object by illuminating the object with pulsed laser light and measuring the reflected pulses with a receiver. Differences in laser return times and wavelengths may then be used to make digital 3-D representations of the object. The light used for LiDAR scan may be ultraviolet, visible, near infrared, etc. Because a narrow laser beam may map physical features with very high resolution, the LiDAR may be particularly suitable for high-definition map surveys. The camera may be configured to obtain one or more images relating to objects (e.g., a person, an animal, a tree, a roadblock, building, or a vehicle) that are within the scope of the camera. Consistent with the present disclosure, the sensors 112 may take measurements of pose information at the same time point where the sensors 112 captures the point cloud data. Accordingly, the pose information may be associated with the respective point cloud data. In some embodiments, the combination of a point cloud data and its associated pose information may be used to position the vehicle(s) 110.

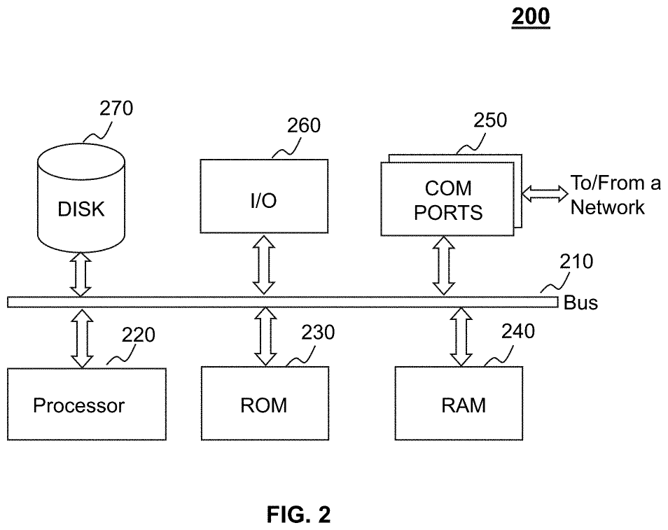

In some embodiments, the server 120 may be a single server or a server group. The server group may be centralized or distributed (e.g., the server 120 may be a distributed system). In some embodiments, the server 120 may be local or remote. For example, the server 120 may access information and/or data stored in the terminal device(s) 130, sensors 112, the vehicle(s) 110, the storage device 140, and/or the positioning and navigation system 160 via the network 150. As another example, the server 120 may be directly connected to the terminal device(s) 130, sensors 112, the vehicle(s) 110, and/or the storage device 140 to access stored information and/or data. In some embodiments, the server 120 may be implemented on a cloud platform or an onboard computer. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 120 may be implemented on a computing device 200 having one or more components illustrated in FIG. 2 in the present disclosure.

In some embodiments, the server 120 may include a processing engine 122. The processing engine 122 may process information and/or data associated with the vehicle(s) 110 to perform one or more functions described in the present disclosure. For example, the processing engine 122 may obtain the point-cloud data acquired by one or more sensors associated with the vehicle(s) 110 during a time period. The point-cloud data may be associated with an initial position of the vehicle. As another example, the processing engine 122 may divide the point-cloud data into a plurality of groups and obtain pose data of the vehicle(s) 110 corresponding to each group of the plurality of groups of the point-cloud data. As a further example, the processing engine 122 may register the each group of the plurality of groups of the point-cloud data to form registered point-cloud data based on the pose data of the vehicle(s) 110. The processing engine 122 may generate a local map associated with the initial position of the vehicle(s) 110 based on the registered point-cloud data. In some embodiments, the processing engine 122 may include one or more processing engines (e.g., single-core processing engine(s) or multi-core processor(s)). Merely by way of example, the processing engine 122 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the server 120 may be connected to the network 150 to communicate with one or more components (e.g., the terminal device(s) 130, the sensors 112, the vehicle(s) 110, the storage device 140, and/or the positioning and navigation system 160) of the autonomous driving system 100. In some embodiments, the server 120 may be directly connected to or communicate with one or more components (e.g., the terminal device(s) 130, the sensors 112, the vehicle(s) 110, the storage device 140, and/or the positioning and navigation system 160) of the autonomous driving system 100. In some embodiments, the server 120 may be integrated in the vehicle(s) 110. For example, the server 120 may be a computing device (e.g., a computer) installed in the vehicle(s) 110.

In some embodiments, the terminal device(s) 130 may include a mobile device 130-1, a tablet computer 130-2, a laptop computer 130-3, a built-in device in a vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistant (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google™ Glass, an Oculus Rift™, a HoloLens™, a Gear VR™, etc. In some embodiments, the built-in device in the vehicle 130-4 may include an onboard computer, an onboard television, etc. In some embodiments, the server 120 may be integrated into the terminal device(s) 130.

The terminal device(s) 130 may be configured to facilitate interactions between a user and the vehicle(s) 110. For example, the user may send a service request for using the vehicle(s) 110. As another example, the terminal device(s) 130 may receive information (e.g., a real-time position, an availability status) associated with the vehicle(s) 110 from the vehicle(s) 110. The availability status may indicate whether the vehicle(s) 110 is available for use. As still another example, the terminal device(s) 130 may be a device with positioning technology for locating the position of the user and/or the terminal device(s) 130, such that the vehicle 110 may be navigated to the position to provide a service for the user (e.g., picking up the user and traveling to a destination). In some embodiments, the owner of the terminal device(s) 130 may be someone other than the user of the vehicle(s) 110. For example, an owner A of the terminal device(s) 130 may use the terminal device(s) 130 to transmit a service request for using the vehicle(s) 110 for the user or receive a service confirmation and/or information or instructions from the server 120 for the user.

The storage device 140 may store data and/or instructions. In some embodiments, the storage device 140 may store data obtained from the terminal device(s) 130, the sensors 112, the vehicle(s) 110, the positioning and navigation system 160, the processing engine 122, and/or an external storage device. For example, the storage device 140 may store point-cloud data acquired by the sensors 112 during a time period. As another example, the storage device 140 may store local maps associated with the vehicle(s) 110 generated by the server 120. In some embodiments, the storage device 140 may store data and/or instructions that the server 120 may execute or use to perform exemplary methods described in the present disclosure. For example, the storage device 140 may store instructions that the processing engine 122 may execute or use to generate, based on point-cloud data, a local map associated with an estimated location. As another example, the storage device 140 may store instructions that the processing engine 122 may execute or use to determine a location of the vehicle(s) 110 by matching a local map with a reference map (e.g., a high-definition map).

In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 140 may be connected to the network 150 to communicate with one or more components (e.g., the server 120, the terminal device(s) 130, the sensors 112, the vehicle(s) 110, and/or the positioning and navigation system 160) of the autonomous driving system 100. One or more components of the autonomous driving system 100 may access the data or instructions stored in the storage device 140 via the network 150. In some embodiments, the storage device 140 may be directly connected to or communicate with one or more components (e.g., the server 120, the terminal device(s) 130, the sensors 112, the vehicle(s) 110, and/or the positioning and navigation system 160) of the autonomous driving system 100. In some embodiments, the storage device 140 may be part of the server 120. In some embodiments, the storage device 140 may be integrated in the vehicle(s) 110.

The network 150 may facilitate exchange of information and/or data. In some embodiments, one or more components (e.g., the server 120, the terminal device(s) 130, the sensors 112, the vehicle(s) 110, the storage device 140, or the positioning and navigation system 160) of the autonomous driving system 100 may send information and/or data to other component(s) of the autonomous driving system 100 via the network 150. For example, the server 120 may receive the point-cloud data from the sensors 112 via the network 150. In some embodiments, the network 150 may be any type of wired or wireless network, or combination thereof. Merely by way of example, the network 150 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 150 may include one or more network access points. For example, the network 150 may include wired or wireless network access points, through which one or more components of the autonomous driving system 100 may be connected to the network 150 to exchange data and/or information.

The positioning and navigation system 160 may determine information associated with an object, for example, one or more of the terminal device(s) 130, the vehicle(s) 110, etc. In some embodiments, the positioning and navigation system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The information may include a location, an elevation, a velocity, or an acceleration of the object, or a current time. The positioning and navigation system 160 may include one or more satellites, for example, a satellite 160-1, a satellite 160-2, and a satellite 160-3. The satellites 170-1 through 170-3 may determine the information mentioned above independently or jointly. The satellite positioning and navigation system 160 may send the information mentioned above to the network 150, the terminal device(s) 130, or the vehicle(s) 110 via wireless connections.

It should be noted that the autonomous driving system 100 is merely provided for the purposes of illustration, and is not intended to limit the scope of the present disclosure. For persons having ordinary skills in the art, multiple variations or modifications may be made under the teachings of the present disclosure. For example, the autonomous driving system 100 may further include a database, an information source, etc. As another example, the autonomous driving system 100 may be implemented on other devices to realize similar or different functions. In some embodiments, the GPS device may also be replaced by other positioning device, such as BeiDou. However, those variations and modifications do not depart from the scope of the present disclosure.

FIG. 2 illustrates a schematic diagram of an exemplary computing device according to some embodiments of the present disclosure. The computing device may be a computer, such as the server 110 in FIG. 1 and/or a computer with specific functions, configured to implement any particular system according to some embodiments of the present disclosure. Computing device 200 may be configured to implement any components that perform one or more functions disclosed in the present disclosure. For example, the server 110 may be implemented in hardware devices, software programs, firmware, or any combination thereof of a computer like computing device 200. For brevity, FIG. 2 depicts only one computing device. In some embodiments, the functions of the computing device may be implemented by a group of similar platforms in a distributed mode to disperse the processing load of the system.

The computing device 200 may include a communication terminal 250 that may connect with a network that may implement the data communication. The computing device 200 may also include a processor 220 that is configured to execute instructions and includes one or more processors. The schematic computer platform may include an internal communication bus 210, different types of program storage units and data storage units (e.g., a hard disk 270, a read-only memory (ROM) 230, a random-access memory (RAM) 240), various data files applicable to computer processing and/or communication, and some program instructions executed possibly by the processor 220. The computing device 200 may also include an I/O device 260 that may support the input and output of data flows between computing device 200 and other components. Moreover, the computing device 200 may receive programs and data via the communication network.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

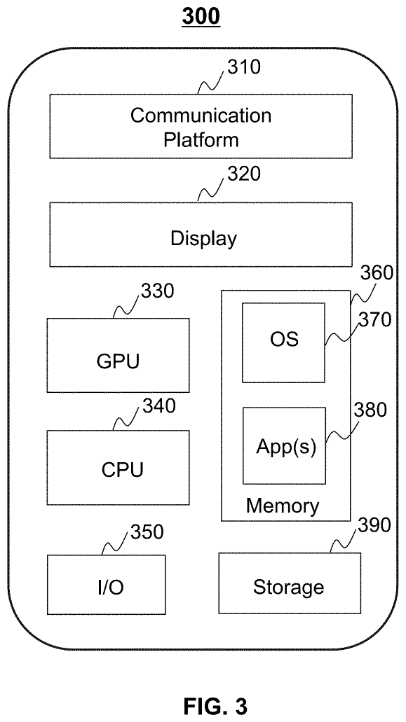

FIG. 3 is a schematic diagram illustrating exemplary hardware and/or software components of an exemplary mobile device on which a terminal device may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and storage 390. In some embodiments, any other suitable component, including but not limited to a system bus or a controller (not shown), may also be included in the mobile device 300. In some embodiments, a mobile operating system 370 (e.g., iOS™, Android™, Windows Phone™) and one or more applications 380 may be loaded into the memory 360 from the storage 390 in order to be executed by the CPU 340. The applications 380 may include a browser or any other suitable mobile apps for receiving and rendering information relating to positioning or other information from the processing engine 122. User interactions with the information stream may be achieved via the I/O 350 and provided to the processing engine 122 and/or other components of the autonomous driving system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

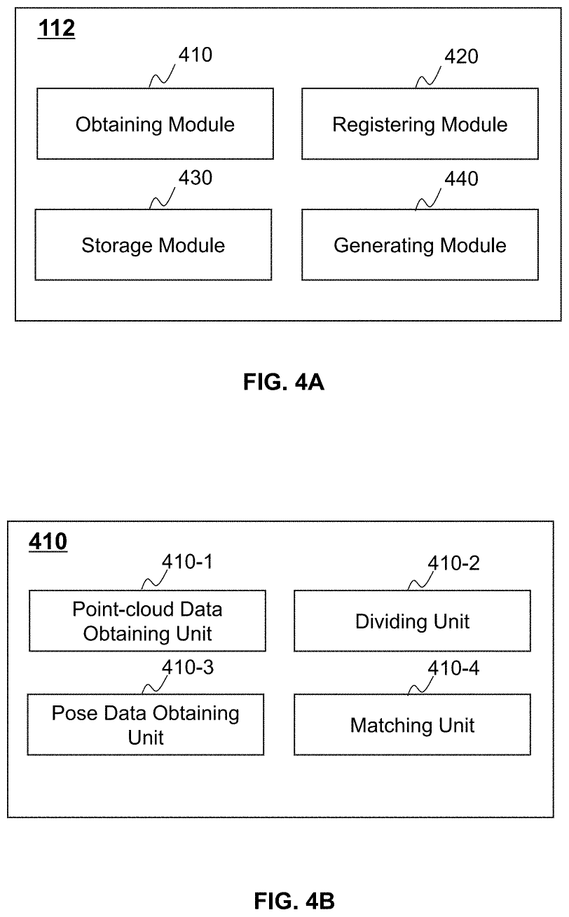

FIG. 4A is a block diagram illustrating an exemplary processing engine according to some embodiments of the present disclosure. In some embodiments, the processing engines 112 may be an embodiment of the processing engine 122 as described in connection with FIG. 1. In some embodiments, the processing engine 122 may be configured to generating a local map associated with a subject based on point cloud data acquired during a time point. As shown in FIG. 4A, the processing engine 122 may include an obtaining module 410, a registering module 420, a storage module 430 and a generating module 440.

The obtaining module 410 may be configured to obtain information related to one or more components of the autonomous driving system 100. For example, the obtaining module 410 may obtain point-cloud data associated with a subject (e.g., the vehicle(s) 110). The point-cloud data may be acquired by one or more sensors (e.g., the sensors 112) during a time period and/or stored in a storage device (e.g., the storage device 140). The point-cloud data may be associated with an initial position of the subject (e.g., the vehicle(s) 110). In some embodiments, the initial position of the subject may refer to a position of the subject at the end of the time period. The initial position of the subject may be also referred to as a current location of the subject. In some embodiments, the obtaining module 410 may divide the point-cloud data into a plurality of groups (also referred to as a plurality of packets). As another example, the obtaining module 410 may obtain pose data of the subject (e.g., the vehicle(s) 110) corresponding to each group of the plurality of groups of the point-cloud data. As used herein, the pose data of the subject corresponding to a specific group of the point-cloud data may refer to that the pose data of the subject and the corresponding specific group of the point-cloud data are generated at a same or similar time point or time period. The pose data may be acquired by one or more sensors (e.g., GPS device and/or IMU unit) during the time period and/or stored in a storage device (e.g., the storage device 140). More descriptions of the obtaining module 410 may be found elsewhere of the present disclosure (e.g., FIG. 4B and the descriptions thereof).

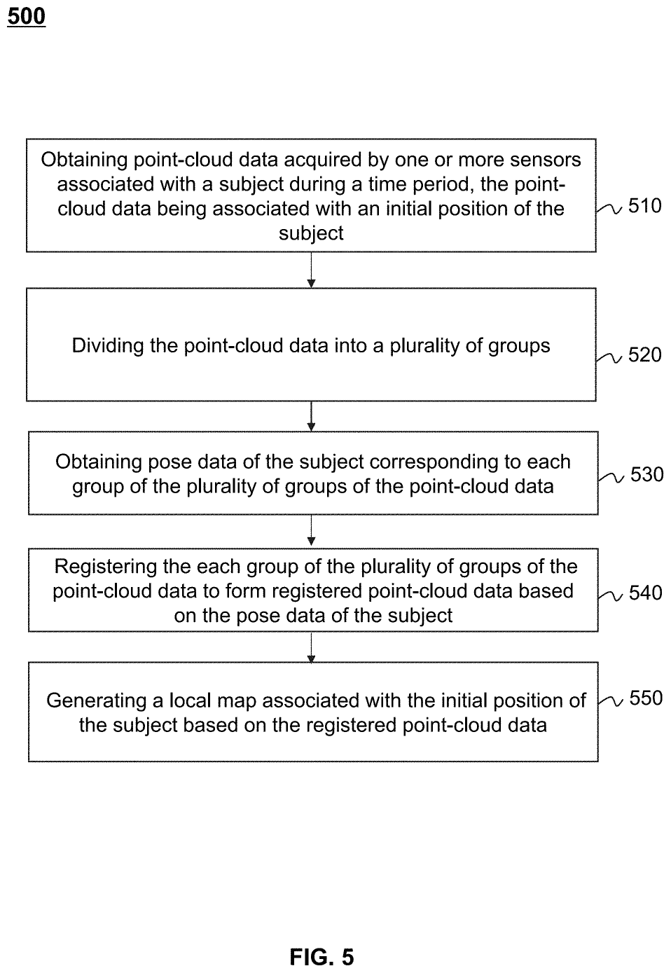

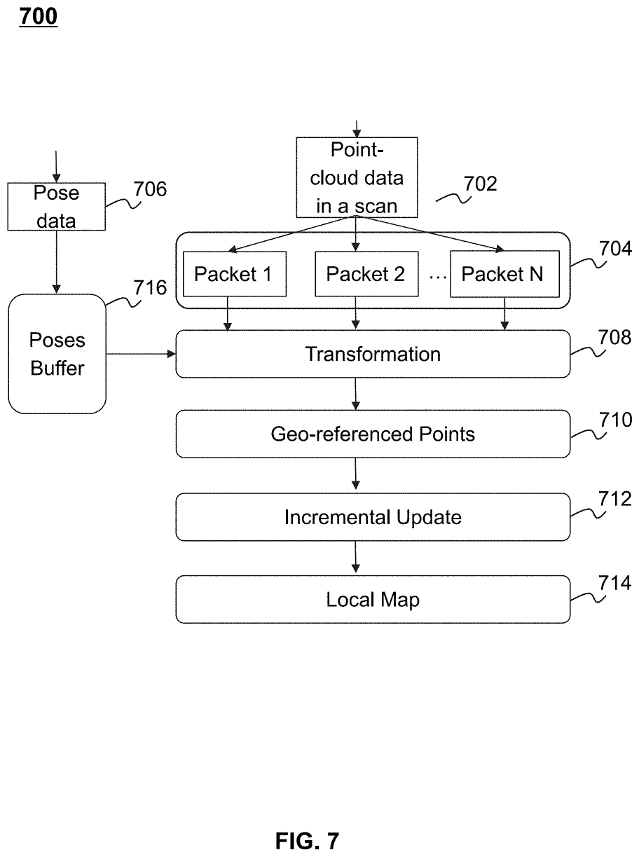

The registering module 420 may be configured to register each group of the plurality of groups of the point-cloud data. As used herein, the registration of the each group of the plurality of groups of the point-cloud data may refer to transform the each group of the plurality of groups of the point-cloud into a same coordinate system. The second coordinate system may include a world space coordinate system, an object space coordinate system, a geographic coordinate system, etc. In some embodiments, the registering module 420 may register the each group of the plurality of groups of the point-cloud data based on the pose data of the subject (e.g., the vehicle(s) 110) using registration algorithms (e.g., coarse registration algorithms, fine registration algorithms). Exemplary coarse registration algorithms may include a Normal Distribution Transform (NDT) algorithm, a 4-Points Congruent Sets (4PCS) algorithm, a Super 4PCS (Super-4PCS) algorithm, a Semantic Keypoint 4PCS (SK-4PCS) algorithm, a Generalized 4PCS (Generalized-4PCS) algorithm, or the like, or any combination thereof. Exemplary fine registration algorithms may include an Iterative Closest Point (ICP) algorithm, a Normal IPC (NIPC) algorithm, a Generalized-ICP (GICP) algorithm, a Discriminative Optimization (DO) algorithm, a Soft Outlier Rejection algorithm, a KD-tree Approximation algorithm, or the like, or any combination thereof. For example, the registering module 420 may register the each group of the plurality of groups of the point-cloud data by transforming the each group of the plurality of groups of the point-cloud data into the same coordinate system (i.e., the second coordinate system) based on one or more transform models (e.g., a rotation model (or matrix), a translation model (or matrix)) More descriptions of the registration process may be found elsewhere in the present disclosure (e.g., operation 540 in FIG. 5, operations 708 and 710 in FIG. 7 and the descriptions thereof).

The storage module 430 may be configured to store information generated by one or more components of the processing engine 112. For example, the storage module 430 may store the one or more transform models determined by the registering module 420. As another example, the storage module 430 may store local maps associated with the initial position of the subject generated by the generating module 440.

The generating module 440 may be configured to generate a local map associated with the initial position of the subject (e.g., the vehicle(s) 110) based on the registered point cloud data. In some embodiments, the generating module 440 may generate the local map by transforming the registered point-cloud data into a same coordinate system. The same coordinate system may be a 2-dimensional (2D) coordinate system. For example, the generating module 440 may project the registered point-cloud data onto a plane in the 2D coordinate system (also referred to as a projected coordinate system). In some embodiments, the generating module 440 may generate the local map based on incremental point-cloud data. The incremental point-cloud data may correspond to additional point-cloud data acquired during another time period after the time period as described in operation 510. More descriptions of generating the local map may be found elsewhere in the present disclosure (e.g., operation 550-560 in FIG. 5 and the descriptions thereof).

The modules may be hardware circuits of all or part of the processing engine 122. The modules may also be implemented as an application or set of instructions read and executed by the processing engine 122. Further, the modules may be any combination of the hardware circuits and the application/instructions. For example, the modules may be the part of the processing engine 122 when the processing engine 122 is executing the application/set of instructions.

It should be noted that the above description of the processing engine 122 is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, any module mentioned above may be implemented in two or more separate units. For example, the functions of the obtaining module 410 may be implemented in four separate units as described in FIG. 4B. In some embodiments, the processing engine 122 may omit one or more modules (e.g., the storage module 430).

FIG. 4B is a block diagram illustrating an exemplary obtaining module according to some embodiments of the present disclosure. In some embodiments, the obtaining module 410 may be an embodiment of the obtaining module 410 as described in connection with FIG. 4A. As shown in FIG. 4B, obtaining module 410 may include a point-cloud obtaining unit 410-1, a dividing unit 410-2, a pose data obtaining unit 410-3 and a matching unit 410-4.

The point-cloud obtaining unit 410-1 may be configured to obtain point-cloud data acquired by one or more sensors (e.g., the sensors 112) associated with a subject (e.g., the vehicle(s) 110) during a time period. The point-cloud data may be associated with an initial position of the subject (e.g., the vehicle(s) 110). In some embodiments, the initial position of the subject may refer to a position of the subject at the end of the time period. The initial position of the subject may be also referred to as a current location of the subject. In some embodiments, the time period may be a duration for the one or more sensors (e.g., LiDAR) fulfilling one single scan. For example, the time period may be 0.1 seconds, 0.05 seconds, etc. In some embodiments, the time period may be a duration for the one or more sensors (e.g., LiDAR) fulfilling a plurality of scans, such as 20 times, 30 times, etc. For example, the time period may be 1 seconds, 2 seconds, 3 seconds, etc. The one or more sensors may include a LiDAR, a camera, a radar, etc., as described elsewhere in the present disclosure (e.g., FIG. 1, and descriptions thereof). More descriptions of the point-cloud data may be found elsewhere in the present disclosure (e.g., operation 510 in FIG. 5 and the descriptions thereof).

The dividing unit 410-2 may be configured to divide the point-cloud data into a plurality of groups. In some embodiments, the dividing unit 410-2 may divide the point-cloud data according to one or more scanning parameters associated with the one or more sensors (e.g., LiDAR) or based on timestamps labeled in the point-cloud data. More descriptions of the dividing process may be found elsewhere in the present disclosure (e.g., operation 520 in FIG. 5 and the descriptions thereof).

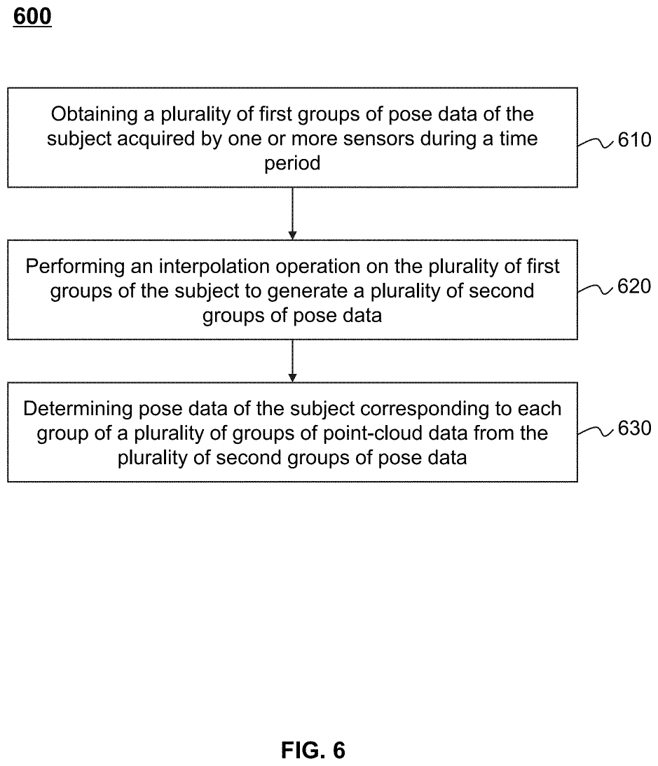

The pose data obtaining unit 410-3 may be configured to obtain a plurality of groups of pose data of the subject acquired by one or more sensors during a time period. The time period may be similar or same as the time period as described in connection with the point-cloud obtaining unit 410-1. In some embodiments, the pose data unit 410-3 may correct or calibrate the plurality of groups of pose data of the subject (e.g., the vehicle(s) 110). For example, the pose data unit 410-3 may perform an interpolation operation on the plurality of groups of pose data (i.e., a plurality of first groups of pose data) of the subject to generate a plurality of second groups of pose data. More descriptions of the plurality of groups of pose data and the correction/calibration process may be found elsewhere in the present disclosure (e.g., operation 530 in FIG. 5, operation 620 in FIG. 6 and the descriptions thereof).

The matching unit 410-4 may be configured to determine pose data of the subject corresponding to each group of a plurality of groups of point-cloud data from the plurality of second groups of pose data. In some embodiments, the matching unit 410-4 may match a specific group of point-cloud data with one of the plurality of second groups of pose data based on a time stamp corresponding to the specific group of point-cloud data and a time stamp corresponding to one of the plurality of second groups of pose data. The time stamp corresponding to the specific group of point-cloud data and the time stamp corresponding to one of the plurality of second groups of pose data may be associated with a same time point or period, or be associated with two similar time points or periods. The two similar time points or periods may refer to that a difference between the two time points is smaller than a predetermined threshold. More descriptions of the matching process may be found elsewhere in the present disclosure (e.g., operation 530 in FIG. 5, operation 630 in FIG. 6 and the descriptions thereof).

FIG. 5 is a flowchart illustrating an exemplary process for generating a local map associated with a subject according to some embodiments of the present disclosure. At least a portion of process 500 may be implemented on the computing device 200 as illustrated in FIG. 2. In some embodiments, one or more operations of process 500 may be implemented in the autonomous driving system 100 as illustrated in FIG. 1. In some embodiments, one or more operations in the process 500 may be stored in a storage device (e.g., the storage device 140, the ROM 230, the RAM 240) as a form of instructions, and invoked and/or executed by the server 110 (e.g., the processing engine 122 in the server 110, or the processor 220 of the computing device 200). In some embodiments, the instructions may be transmitted in a form of electronic current or electrical signals. The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 510, the processing engine 122 (e.g., the obtaining module 410, the point-cloud data obtaining unit 410-1) may obtain point-cloud data acquired by one or more sensors (e.g., the sensors 112) associated with a subject (e.g., the vehicle(s) 110) during a time period. The point-cloud data may be associated with an initial position of the subject (e.g., the vehicle(s) 110). In some embodiments, the initial position of the subject may refer to a position of the subject at the end of the time period. The initial position of the subject may be also referred to as a current location of the subject. In some embodiments, the time period may be a duration for the one or more sensors (e.g., LiDAR) fulfilling one single scan. For example, the time period may be 0.1 seconds, 0.05 seconds, etc. In some embodiments, the time period may be a duration for the one or more sensors (e.g., LiDAR) fulfilling a plurality of scans, such as 20 times, 30 times, etc. For example, the time period may be 1 seconds, 2 seconds, 3 seconds, etc. The one or more sensors may include a LiDAR, a camera, a radar, etc., as described elsewhere in the present disclosure (e.g., FIG. 1, and descriptions thereof).

The point-cloud data may be generated by the one or more sensors (e.g., LiDAR) via scanning a space around the initial location of the subject via, for example, emitting laser pulses according to one or more scanning parameters. Exemplary scanning parameters may include a measurement range, a scanning frequency, an angle resolution, etc. The scanning frequency of a sensor (e.g., LiDAR) may refer to a scanning count (or times) of the sensor per second. In some embodiments, the scanning frequency of a sensor may be 10 Hz, 15 Hz, etc., that means the sensor may scan 10 times, 15 times, etc., per second. For example, if the time period is 2 seconds, the point-cloud data may be generated by the one or more sensors scanning 20 times. The angle resolution of a sensor may refer to an angle step during a scan of the sensor. For example, the angle resolution of a sensor may be 0.9 degree, 0.45 degree, etc. The measurement range of a sensor may be defined by a maximum scanning distance and/or a total scanning degree that the sensor fulfills one single scan. For example, the maximum scanning distance of a sensor may be 5 meters, 10 meters, 15 meters, 20 meters, etc. The total scanning degree that a sensor fulfills one single scan may be 360 degrees, 180 degrees, 120 degrees, etc.

In some embodiments, the processing engine 122 may obtain the point-cloud data associated with the initial location from the one or more sensors (e.g., the sensors 112) associated with the subject, a storage (e.g., the storage device 140), etc., in real time or periodically. For example, the one or more sensors may send point-cloud data generated by the one or more sensors via scanning one time to the processing engine 122 once the one or more sensors fulfill one single scan. As another example, the one or more sensors may send point-cloud data generated in every scan during a period time to the storage (e.g., the storage device 140). The processing engine 122 may obtain the point-cloud data from the storage periodically, for example, after the time period. In some embodiments, the point-cloud data may be generated by the one or more sensors (e.g., LiDAR) when the subject is immobile. In some embodiments, the point-cloud data may be generated when the subject is moving.

The point-cloud data may refer to a set of data points associated with one or more objects in the space around the current location of the subject (e.g., the vehicle(s) 110). A data point may correspond to a point or region of an object. The one or more objects around the subject may include a lane mark, a building, a pedestrian, an animal, a plant, a vehicle, etc. In some embodiments, the point-cloud data may have a plurality of attributes (also referred to as feature data). The plurality of attributes of the point-cloud data may include point-cloud coordinates (e.g., X, Y and Z coordinates) of each data point, elevation information associated with each data point, intensity information associated with each data point, a return number, a total count of returns, a classification of each data point, a scan direction, or the like, or any combination thereof. As used herein, “point-cloud coordinates of a data point” may be denoted by a point-cloud coordinate system (i.e., first coordinate system). The first coordinate system may be a coordinate system associated with the subject or the one or more sensors, i.e., a particular pose (e.g., position) of the subject corresponding to a particular scan. “Elevation information associated with a data point” may refer to height of the data point above or below a fixed reference point, line or plane (e.g., most commonly a reference geoid, a mathematical model of the Earth's sea level as an equipotential gravitational surface). “Intensity information associated with a data point” may refer to return strength of the laser pulse emitted from the sensor (e.g., LiDAR) and reflected by an object for generating the data point. “Return number” may refer to the pulse return number for a given output laser pulse emitted from the sensor (e.g., LiDAR) and reflected by the object. In some embodiments, an emitted laser pulse may have various levels of returns depending on features it is reflected from and capabilities of the sensor (e.g., a laser scanner) used to collect the point-cloud data. For example, the first return may be flagged as return number one, the second return as return number two, and so on. “Total count of returns” may refer to the total number of returns for a given pulse. “Classification of a data point” may refer to a type of data point (or the object) that has reflected the laser pulse. For example, the set of data points may be classified into a number of categories including bare earth or ground, a building, a person, water, etc. “Scan direction” may refer to the direction in which a scanning mirror in the LiDAR was directed when a data point was detected.

In some embodiments, the point-cloud data may consist of a plurality of point-cloud frames. A point-cloud frame may include a portion of the point-cloud data generated by the one or more sensors (e.g., LiDAR) at an angle step. Each point-cloud frame of the plurality of point-cloud frames may be labeled with a particular timestamp, which indicates that each point-cloud frame is captured at a particular time point or period corresponding to the particular timestamp. Taking the time period of 0.1 seconds as an example, the one or more sensors (e.g., LiDAR) may scan the environment surrounding the subject (e.g., the vehicle(s) 110) 10 times per second (i.e., one time per 100 milliseconds). Each single scan may correspond to a total scanning degree 360 degree. The angle resolution may be 0.9 degree. The point-cloud data acquired by the one or more sensors (e.g., LiDAR) by a single scan may correspond to 400 point-cloud frames.

In 520, the processing engine 122 (e.g., the obtaining module 410, the dividing unit 410-2) may divide the point-cloud data into a plurality of groups. A group of point-cloud data may be also referred to as a packet.

In some embodiments, the processing engine 122 may divide the point-cloud data according to one or more scanning parameters associated with the one or more sensors (e.g., LiDAR). For example, the processing engine 122 may divide the point-cloud data into the plurality of groups based on the total scanning degree of the one or more sensors in one single scan. The processing engine 122 may designate one portion of the point-cloud data acquired in a pre-determined sub-scanning degree as one group. The pre-determined sub-scanning degree may be set by a user or according to a default setting of the automobile driving system 100, for example, one ninth of the total scanning degree, one eighteenth of the total scanning degree, etc. As another example, the processing engine 122 may divide the point-cloud data into the plurality of groups based on the angle resolution. The processing engine 122 may designate one portion of the point-cloud data acquired in several continuous angle steps, for example, 10 continuous angle steps, 20 continuous angle steps, etc., as one group. In other words, the processing engine 122 may designate several continuous frames (e.g., 10 continuous frames, 20 continuous frames, etc.) as one group.

In some embodiments, the processing engine 122 may divide the point-cloud data into the plurality of groups based on timestamps labeled in the plurality of point-cloud frames of the point-cloud data. That is, the plurality of groups may correspond to the plurality of point-cloud frames respectively, or each group of the plurality of groups may correspond to a pre-determined number of continuous point-cloud frames that are labeled with several continuous timestamps. For example, if the point-cloud data includes 200 point-cloud frames, the point-cloud data may be divided into 200 groups corresponding to the 200 point-cloud frames or 200 timestamps thereof, respectively. As another example, the processing engine 122 may determine a number of the plurality of groups. The processing engine 122 may divide the point-cloud data into the plurality of groups averagely. As a further example, if the point-cloud data includes 200 point-cloud frames, and the number of the plurality of groups is 20, the processing engine 122 may divide 10 continuous point-cloud frames into each of the plurality of groups.

In some embodiments, the point-cloud data may be acquired in a plurality of scans. The point-cloud data acquired in each of the plurality of scans may be divided into a same or different counts of groups. Taking the time period of 2 seconds as an example, the one or more sensors (e.g., LiDAR) may scan the environment surrounding the subject (e.g., the vehicle(s) 110) 10 times per second (i.e., one time per 100 milliseconds). The point-cloud data during the time period (i.e., 2 seconds) may be acquired by the one or more sensors (e.g., LiDAR) via 20 scans. The point-cloud data acquired by each single scan of the 20 scans may correspond to 100 point-cloud frames. The point-cloud data acquired in the each single scan may be divided into 10 groups. As another example, point-cloud data generated in a first scan may be divided into a first number of groups. Pont-cloud data generated in a second scan may be divided into a second number of groups. The first number may be different from the second number.

In some embodiments, each of the plurality of groups of the point-cloud data may be labeled a first time stamp. In some embodiments, the first time stamp corresponding to a specific group of the point-cloud data may be determined based on time stamps corresponding to point-cloud frames in the specific group. For example, the first time stamp corresponding to a specific group of the point-cloud data may be a time stamp corresponding to one of point-cloud frames in the specific group, for example, the last one of the point-cloud frames in the specific group, the earliest one of the point-cloud frames in the specific group, or any one of the point-cloud frames in the specific group, etc. As another example, the processing engine 122 may determine an average time stamp based on the time stamps corresponding to the point-cloud frames in the specific group.

In 530, the processing engine 122 (e.g., the obtaining module 410, the pose data obtaining unit 410-3, or the matching unit 410-4) may obtain pose data of the subject (e.g., the vehicle(s) 110) corresponding to each group of the plurality of groups of the point-cloud data. As used herein, the pose data of the subject corresponding to a specific group of the point-cloud data may refer to that the pose data of the subject and the corresponding specific group of the point-cloud data are generated at a same or similar time point or time period.

The pose data of the subject (e.g., the vehicle(s) 110) may include geographic location information and/or IMU information of the subject (e.g., the vehicle(s) 110) corresponding to each of the plurality of groups of the point-cloud data. The geographic location information may include a geographic location of the subject (e.g., the vehicle(s) 110) corresponding to each of the plurality of groups. The geographic location of the subject (e.g., the vehicle(s) 110) may be represented by 3D coordinates in a coordinate system (e.g., a geographic coordinate system). The IMU information may include a pose of the subject (e.g., the vehicle(s) 110) defined by a flight direction, a pitch angle, a roll angle, etc., acquired when the subject locates at the geographic location. The geographic location information and IMU information of the subject corresponding to a specific group of the point-cloud data may correspond to a same or similar time stamp as a first time stamp of the specific group of the point-cloud data.

In some embodiments, the processing engine 122 may obtain the pose data corresponding to a specific group of the point-cloud data based on the first time stamp corresponding to the specific group of the point-cloud data. For example, the processing engine 122 may obtain a plurality of groups of pose data acquired by the one or more sensors (e.g., GPS device and/or IMU unit) during the time period. Each of the plurality of groups of pose data may include a geographic location and a pose corresponding to a second time stamp. The processing engine 122 may match the specific group of the point-cloud data with one of the plurality of groups of pose data by comparing the first time stamp and the second time stamp. If a difference between the first time stamp and the second time stamp is smaller than a threshold, the processing engine 122 may determine that the specific group of the point-cloud data is matched with the one of the plurality of groups of pose data. The threshold may be set by a user or according to a default setting of the automobile driving system 100. For example, the threshold may be 0, 0.1 millisecond, etc.

In some embodiments, the processing engine 122 may correct or calibrate the plurality of groups of pose data of the subject (e.g., the vehicle(s) 110) to determine the pose data corresponding to the each group of the plurality of groups. For example, the processing engine 122 may perform an interpolation operation on the plurality of groups of pose data (i.e., a plurality of first groups of pose data) of the subject to generate a plurality of second groups of pose data. Then the processing engine 122 may determine the pose data corresponding to each of the plurality of groups of the point-cloud data from the plurality of second groups of pose data. More descriptions of obtaining the pose data of the subject corresponding to the each group may be found elsewhere in the present disclosure (e.g., FIG. 6 and the descriptions thereof).

In 540, the processing engine 122 (e.g., the registering module 420) may register each group of the plurality of groups of the point-cloud data to form registered point-cloud data based on the pose data of the subject (e.g., the vehicle(s) 110). As used herein, the registration of the each group of the plurality of groups of the point-cloud data may refer to transform the each group of the plurality of groups of the point-cloud into a same coordinate system (i.e., a second coordinate system). The second coordinate system may include a world space coordinate system, an object space coordinate system, a geographic coordinate system, etc.

In some embodiments, the processing engine 122 may register the each group of the plurality of groups of the point-cloud data based on the pose data of the subject (e.g., the vehicle(s) 110) using registration algorithms (e.g., coarse registration algorithms, fine registration algorithms). Exemplary coarse registration algorithms may include a Normal Distribution Transform (NDT) algorithm, a 4-Points Congruent Sets (4PCS) algorithm, a Super 4PCS (Super-4PCS) algorithm, a Semantic Keypoint 4PCS (SK-4PCS) algorithm, a Generalized 4PCS (Generalized-4PCS) algorithm, or the like, or any combination thereof. Exemplary fine registration algorithms may include an Iterative Closest Point (ICP) algorithm, a Normal IPC (NIPC) algorithm, a Generalized-ICP (GICP) algorithm. a Discriminative Optimization (DO) algorithm, a Soft Outlier Rejection algorithm, a KD-tree Approximation algorithm, or the like, or any combination thereof. For example, the processing engine 122 may register the each group of the plurality of groups of the point-cloud data by transforming the each group of the plurality of groups of the point-cloud data into the same coordinate system (i.e., the second coordinate system) based on one or more transform models. The transform model may include a translation transformation model, a rotation transformation model, etc. The transform model corresponding to a specific group of the point-cloud data may be used to transform the specific group of the plurality of the point-cloud data in the first coordinate system to the second coordinate system. The transform model corresponding to a specific group of the point-cloud data may be determined based on the pose data corresponding to the specific group of the point-cloud data. For example, the translation transformation model corresponding to a specific group of the point-cloud data may be determined based on geographic location information corresponding to the specific group of the point-cloud data. The rotation transformation model corresponding to the specific group of the point-cloud data may be determined based on IMU information corresponding to the specific group of the point-cloud data. Different groups of the point-cloud data may correspond to different pose data. Different groups of the plurality of groups may correspond to different transform models. The transformed point-cloud data corresponding to the each group may be designated as the registered point-cloud data corresponding to the each group. More descriptions of the transformation process may be found elsewhere in the present disclosure (e.g., operations 708 and 710 in FIG. 7 and the descriptions thereof).

In 550, the processing engine 122 (e.g., the generating module 440) may generate a local map associated with the initial position of the subject (e.g., the vehicle(s) 110) based on the registered point cloud data. In some embodiments, the local map may be a set of registered point cloud data of a square area with M×M meters (i.e., a square area with a side length of M meters) that is centered on the initial position of the subject (e.g., the vehicle(s) 110). The local map may present objects within the square area with M×M meters in a form of an image based on the registered point cloud data. M may be 5, 10, etc. The local map may include a first number of cells. Each cell of the first number of cells may correspond to a sub-square area with N×N centimeters (e.g., 10×10 centimeters, 15×15 centimeters, etc.). Each cell of the first number of cells may correspond to a volume, a region or a portion of data points associated with the registered point-cloud data in the second coordinate system. In some embodiments, the local map may be denoted by a third coordinate system. The third coordinate system may be a 2-dimensional (2D) coordinate system.

In some embodiments, the processing engine 122 may generate the local map by transforming the registered point-cloud data in the second coordinate system into the third coordinate system. The processing engine 122 may transform the registered point-cloud data from the second coordinate system into the third coordinate system based on a coordinate transformation (e.g., a seven parameter transformation) to generate transformed registered point-cloud data. For example, the processing engine 122 may project the registered point-cloud data in the second coordinate system onto a plane in the third coordinate system (also referred to as a projected coordinate system). The plane may be denoted by a grid. The grid may include a second number of cells. The second number of cells may be greater than the first number of cells. The processing engine 122 may then match data points associated with the registered point-cloud data with each of the plurality of cells based on coordinates of data points associated with the registered point-cloud data denoted by the second coordinate system and the third coordinate system, respectively. The processing engine 122 may map feature data (i.e., attributes of the data points) in the registered point-cloud data into one or more corresponding cells of the plurality of cells. The feature data may include at least one of intensity information (e.g., intensity values) and/or elevation information (e.g., elevation values) received by the one or more sensors. In some embodiments, the processing engine 122 may determine a plurality of data points corresponding to one of the plurality of cells. The processing engine 122 may perform an average operation on the feature data presented in the registered point-cloud data associated with the plurality of data points, and map the averaged feature data into the cell. In response to a determination that one single data point associated with the registered point-cloud data corresponding to a cell of the plurality of cells, the processing engine 122 may map the feature data presented in the registered point-cloud data associated with the one single data point into the cell.

In some embodiments, the processing engine 122 may generate the local map based on incremental point-cloud data. The incremental point-cloud data may correspond to additional point-cloud data acquired during another time period after the time period as described in operation 510. For example, the incremental point-cloud data may be acquired by the one or more sensors (e.g., LiDAR) via performing another scan after the point-cloud data is acquired as described in operation 510. The processing engine 122 may generate the local map by updating one portion of the second number of cells based on the incremental point-cloud data. For example, the incremental point-cloud data may be transformed into the second coordinate system according to operation 540 based on pose data of the subject corresponding to the incremental point-cloud data. The incremental point-cloud data in the second coordinate system may be further transformed from the second coordinate system to the third coordinate system according to operation 550. In other words, the incremental point-cloud data in the second coordinate system may be projected onto the plane defined by the third coordinate system. The feature data presented in the incremental point-cloud data may be mapped to one portion the second number of cells corresponding to the incremental point-cloud data. In some embodiments, the processing engine 122 may delete one or more cells far away from the center of at least one portion of the second number of cells that have been mapped with the registered point-cloud data obtained in operation 540. Then the processing engine 122 may add one or more cells matching with the incremental point-cloud data in the grid. The processing engine 122 may further map the feature data presented in the incremental point-cloud data in the one or more addition cells. The local map may be generated based on more incremental point-cloud data acquired by the one or more sensors via performing each scan of a plurality of scans. The plurality of scans may be 10 times, 20 times, 30 times, etc. After the more incremental point-cloud data generated in the plurality of the scans are mapped on the grid, the processing engine 122 may designate one portion of the grid including the first number of cells corresponding to the square area with M×M meters as the local map.

In some embodiments, the processing engine 122 may update the point-cloud data obtained as described in 510 using the incremental point-cloud data. The processing engine 122 may generate the local map based on the updated point-cloud data according to operations 520 to 550.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added. For example, operation 510 and operation 520 may be operated simultaneously. As another example, operation 530 may be divided into two steps. One step may obtain pose data of the subject during the time period, and another step may match pose data of the subject with each group of the plurality of groups of the point-cloud data. In some embodiments, process 500 may further include positioning the subject based on the local map and a high-definition map.

FIG. 6 is a flowchart illustrating an exemplary process for obtaining pose data of a subject corresponding to each group of a plurality of groups of point cloud data according to some embodiments of the present disclosure. At least a portion of process 600 may be implemented on the computing device 200 as illustrated in FIG. 2. In some embodiments, one or more operations of process 600 may be implemented in the autonomous driving system 100 as illustrated in FIG. 1. In some embodiments, one or more operations in the process 600 may be stored in a storage device (e.g., the storage device 140, the ROM 230, the RAM 240) as a form of instructions, and invoked and/or executed by the server 110 (e.g., the processing engine 122 in the server 110, or the processor 220 of the computing device 200). The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 6 and described below is not intended to be limiting. In some embodiments, operation 530 as described in connection with FIG. 5 may be performed according to process 600 as illustrated in FIG. 6.

In 610, the processing engine 122 (e.g., the obtaining module 410, the pose data obtaining unit 410-3) may obtain a plurality of first groups of pose data of the subject acquired by one or more sensors during a time period. The time period may be similar or the same as the time period as described in connection with operation 510. For example, the time period may be 0.1 seconds, 0.05 seconds, etc. Each group of the plurality of first groups of pose data of the subject (e.g., the vehicle(s) 110) may include geographic location information, IMU information and time information of the subject acquired by the one or more sensors (e.g., GPS device and/or IMU sensor) during the time period. The geographic location information in a first group may include a plurality of geographic locations that the subject (e.g., the vehicle(s) 110) locates. A geographic location of the subject (e.g., the vehicle(s) 110) may be represented by 3D coordinates in a coordinate system (e.g., a geographic coordinate system). The IMU information in the first group may include a plurality of poses of the subject when the subject locates at the plurality of geographic locations respectively. Each of the plurality of poses in the first group may be defined by a flight direction, a pitch angle, a roll angle, etc., of the subject (e.g., the vehicle(s) 110). The time information in the first group may include a time stamp corresponding to the first group of pose data.

In some embodiments, the processing engine 122 may obtain the plurality of first groups of pose data from one or more components of the autonomous driving system 100. For example, the processing engine 122 may obtain each of the plurality of first groups of pose data from the one or more sensors (e.g., the sensors 112) in real time or periodically. As a further example, the processing engine 122 may obtain the geographic location information of the subject in a first group via a GPS device (e.g., GPS receiver) and/or the IMU information in the first group via an inertial measurement unit (IMU) sensor mounted on the subject.

In some embodiments, the GPS device may receive geographic locations with a first data receiving frequency. The first data receiving frequency of the GPS device may refer to the location updating count (or times) per second. The first data receiving frequency may be 10 Hz, 20 Hz, etc., that means the GPS device may receive one geographic location every 0.1 s, 0.05 s, etc., respectively. The IMU sensor may receive IMU information with a second data receiving frequency. The second data receiving frequency of the IMU sensor may refer to the IMU information (e.g., poses of a subject) updating count (or times) per second. The second data receiving frequency of the IMU sensor may be 100 Hz, 200 Hz, etc., that means the IMU sensor may receive IMU data for one time every 0.01 s, 0.005 s, etc., respectively. Accordingly, the first data receiving frequency may be lower than the second data receiving frequency that means during a same time period, the IMU sensor may receive more poses than geographic locations received by the GPS device. In some embodiments, the processing engine 122 may obtain a plurality of geographic locations and a plurality of poses during the time period. The processing engine 122 may further match one of the plurality of geographic locations and a pose based on the time information to obtain a first group of pose data. As used herein, the matching between a geographic location with a pose may refer to determine the geographic location where the pose is acquired. In some embodiments, the processing engine 122 may perform an interpolation operation on the plurality of geographic locations to match poses and geographic locations. Exemplary interpolation operations may include using a spherical linear interpolation (Slerp) algorithm, a Geometric Slerp algorithm, a Quaternion Slerp algorithm, etc.

In 620, the processing engine 122 (e.g., the obtaining module 410, the pose data obtaining unit 410-3) may perform an interpolation operation on the plurality of first groups of pose data of the subject to generate a plurality of second groups of pose data. Exemplary interpolation operations may include using a spherical linear interpolation (Slerp) algorithm, a Geometric Slerp algorithm, a Quaternion Slerp algorithm, etc. The plurality of second groups of pose data may have a higher precision in comparison with the plurality of first groups of pose data. Each group of the plurality of second groups of pose data may correspond to a time stamp. In some embodiments, the processing engine 122 may perform the interpolation operation on geographic location information, IMU information and time information of the subject (or the sensors 112) in the plurality of first groups of pose data simultaneously using the spherical linear interpolation (Slerp) algorithm to obtain the plurality of second groups of pose data. The number of the plurality of second groups of pose data may be greater than that of the plurality of first groups of pose data. In other words, the accuracy of the geographic location information, the IMU information in the plurality of second groups of pose data may be higher than the geographic location information, the IMU information in the plurality of first groups of pose data. For example, if the plurality of first groups of pose data include location L1 with pose P1 corresponding to a time stamp t1, and location L3 with pose P3 corresponding to a time stamp t3. The plurality of second groups of pose data may include location L1 with pose P1 corresponding to a time stamp t1, location L2 with pose P2 corresponding to a time stamp t2, and location L3 with pose P3 corresponding to a time stamp t3. Location L2, pose P2, and time stamp t2 may be between Location L1, pose P1, and time stamp t1 and Location L3, pose P3, and time stamp t3, respectively.

In 630, the processing engine 122 (e.g., the obtaining module 410, the matching unit 410-4) may determine pose data of the subject corresponding to each group of a plurality of groups of point-cloud data from the plurality of second groups of pose data.

The processing engine 122 (e.g., the obtaining module 410, the matching unit 410-4) may match a specific group of point-cloud data with one of the plurality of second groups of pose data based on a time stamp corresponding to the specific group of point-cloud data and a time stamp corresponding to one of the plurality of second groups of pose data. For example, as described in connection with FIG. 5, each of the plurality of groups of the point-cloud data may correspond to a first time stamp. A second group of pose data may correspond to a second time stamp. The processing engine 122 (e.g., the obtaining module 410, the matching unit 410-4) may match a specific group of point-cloud data with a second group of pose data by matching a first time stamp corresponding to the specific time stamp and a second time stamp corresponding to the second group of pose data. The matching between a first time stamp and a second time stamp may refer to that the first timestamp and the second timestamp may be associated with a same time point or period. The matching between a first time stamp and a second time stamp may be determined based on a difference between the first time stamp and the second time stamp. If the difference between the first time stamp and the second time stamp is smaller than a threshold, the processing engine 122 may determine that the first time stamp and the second time stamp match with each other. The threshold may be set by a user or according to a default setting of the automobile driving system 100.

It should be noted that the above description of the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added.

FIG. 7 is a flowchart illustrating an exemplary process for generating a local map associated with a subject according to some embodiments of the present disclosure. At least a portion of process 700 may be implemented on the computing device 200 as illustrated in FIG. 2. In some embodiments, one or more operations of process 600 may be implemented in the autonomous driving system 100 as illustrated in FIG. 1. In some embodiments, one or more operations in the process 700 may be stored in a storage device (e.g., the storage device 140, the ROM 230, the RAM 240) as a form of instructions, and invoked and/or executed by the server 110 (e.g., the processing engine 122 in the server 110, or the processor 220 of the computing device 200). The operations of the illustrated process present below are intended to be illustrative. In some embodiments, the process 500 may be accomplished with one or more additional operations not described and/or without one or more of the operations herein discussed. Additionally, the order in which the operations of the process as illustrated in FIG. 7 and described below is not intended to be limiting. In some embodiments, process 700 may be described in connection with operations 510-550 in FIG. 5.

In 702, point-cloud data for a scan may be obtained. The processing engine 122 (e.g., the obtaining module 410, the point-cloud data obtaining unit 410-1) may obtain point-cloud data acquired by one or more sensors associated with a subject (e.g., the vehicle(s) 110) via scanning a space one time around a current location of a subject as described in connection with operation 510. The point-cloud data may be associated with the current position of the subject (e.g., the vehicle(s) 110). In some embodiments, the subject may be moving when the one or more sensors (e.g., LiDAR) perform the scan. The current position of the subject may refer to a position that the subject locates when the one or more sensors (e.g., LiDAR) fulfill the scan. Details of operation 710 may be the same as or similar to operation 510 as described in FIG. 5.

In 704, the point-cloud data may be divided into a plurality of packets (or groups), for example, Packet 1, Packet 2, . . . , Packet N. Each of the plurality of packets may correspond to a first time stamp. The processing engine 122 (e.g., the obtaining module 410, the dividing unit 410-2) may divide the point-cloud data into the plurality of packets based on one or more scanning parameters of the one or more sensors (e.g., LiDAR), such as the total scanning degree of the one or more sensors for fulfilling the scan. In some embodiments, the processing engine 122 may divide the point-cloud data into the plurality of packets according to operation 520 as described in FIG. 5. Each of the plurality of packets of the point-cloud data may include a plurality of data points. The positions of the plurality of data points in a packet may be denoted by a first coordinate system associated with the one or more sensors corresponding to the packet. Different packets may correspond to different first coordinate systems.

In 706, pose data associated with the subject (e.g., the vehicle(s) 110) may be obtained. The processing engine 122 (e.g., the obtaining module 410, the pose data obtaining unit 410-3, or the matching unit 410-4) may obtain the pose data of the subject (e.g., the vehicle(s) 110) corresponding to each packet of the plurality of packets of the point-cloud data from a pose buffer 716. Details of operation 730 may be the same as or similar to operation 530 in FIG. 5 and FIG. 6.

In 708 and 710, the plurality of packets of the point-cloud data may be transformed to generate geo-referenced points based on the pose data. The processing engine 122 (e.g., the registering module 420) may generate the geo-referenced points by transforming the each packet of the plurality of packets of the point-cloud data in the first coordinate system into a same coordinate system (i.e., a second coordinate system) based on the pose data.

In some embodiments, the second coordinate system may be any 3D coordinate system, for example, a geographic coordinate system. For the each packet of the plurality of packets of the point-cloud data, the processing engine 122 may determine one or more transform models (e.g., a rotation transformation model (or matrix), a translation transformation model (or matrix)) that can be used to transform coordinates of data points in the each packet of the plurality of packet of the point-cloud data denoted by the first coordinate system into coordinates of the geo-referenced points denoted by the geographic coordinate system. For example, the processing engine 122 may determine the one or more transform models according to Equation (1) as illustrated below:

$${p}_{t} = R \cdot {p}_{s} + T , \qquad ( 1 )$$

where pₛ refers to coordinates of data points in a specific packet denoted by the first coordinate system, pₜ refers to coordinates of geo-referenced points denoted by the second coordinate system (e.g., geographic coordinate system) corresponding to the corresponding data points in the specific packet, R refers to a rotation transformation matrix, and T refers to a translation transformation matrix. pₛ may be transformed into pₜ based on R and T. For the plurality of packets of the point-cloud data and corresponding pose data, the processing engine 122 may determine an optimized R and an optimized T based on any suitable mathematical optimization algorithms (e.g., a least square algorithm). Then, the processing engine 122 may transform the each packet of the plurality of packets of the point-cloud data from the first coordinate system into the second coordinate system based on the an optimized R and an optimized T to generate transformed point-cloud data corresponding to the each packet. For different packets, the pose data may be different and the transform models (e.g., R, T) may be different.

In 712 and 714, incremental update may be performed to generate a local map associated with the current location of the subject. The processing engine 122 (e.g., the generating module 440) may project the transformed point-cloud data on a plane corresponding to a third coordinate system. The third coordinate system may be a 2D coordinate system having a center with the current position of the subject.

In some embodiments, the transformed point-cloud data (i.e., geo-referenced points) may be projected onto the plane based on different projection technique (e.g., an Albers projection, a Mercator projection, a Lambert projection, a Gauss-Kruger projection, etc.). The plane may be denoted by a grid including a plurality of cells. The processing engine 122 may determine a cell corresponding to each of the geo-referenced points. Then the processing engine 122 may fill the cell using feature data (e.g., intensity information and/or elevation information) corresponding to the geo-referenced point. Each of the geo-referenced points may correspond to a cell. As used herein, a geo-referenced point corresponding to a cell may refer to that coordinates of the geo-reference point may be located at the cell after the coordinates of the geo-reference point is transformed into coordinates in the third coordinate system. The incremental update then may be performed to generate the local map. The incremental update may refer to obtain incremental point-cloud data generate by the one or more sensors via scanning the space around the subject in a next time and update at least one portion of the plurality of cells in the grid corresponding to the incremental point-cloud data. In some embodiments, the processing engine 122 may delete one portion of the plurality of cells that is far away from the center of the grid (i.e., the current position). The processing engine 122 may then map feature data of the incremental point-cloud data into the corresponding cells. Details of operations 712 and 714 may be the same as or similar to operation 550 in FIG. 5.

It should be noted that the above description regarding the process 700 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, one or more operations may be omitted and/or one or more additional operations may be added.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for positioning, comprising:
at least one storage medium storing a set of instructions;
at least one processor in communication with the at least one storage medium, when executing the stored set of instructions, the at least one processor causes the system to:
obtain point-cloud data acquired by one or more sensors associated with a subject during a time period, the point-cloud data being associated with an initial position of the subject;
divide the point-cloud data into a plurality of groups;
obtain pose data of the subject corresponding to each group of the plurality of groups of the point-cloud data;
register, based on the pose data of the subject, the each group of the plurality of groups of the point-cloud data to form registered point-cloud data; and
generate, based on the registered point-cloud data, a local map associated with the initial position of the subject.

2. The system of claim 1, wherein the each group of the plurality of groups of the point-cloud data corresponds to a time stamp, and to obtain the pose data of the subject corresponding to the each group of the plurality of groups of the point-cloud data, the at least one processor is further configured to cause the system to:
determine, based on the time stamp, the pose data of the subject corresponding to the each group of the plurality of groups of the point-cloud data.

3. The system of claim 1, wherein to obtain the pose data of the subject corresponding to the each group of the plurality of groups of the point-cloud data, the at least one processor is further configured to cause the system to:
obtain a plurality of first groups of pose data of the subject during the time period;
perform an interpolation operation on the plurality of first groups of pose data of the subject to generate a plurality of second groups of pose data; and
determine, from the plurality of second groups of pose data, the pose data of the subject corresponding to the each group of the plurality of groups of the point-cloud data.

4. The system of claim 3, wherein the at least one processor is configured to cause the system to:
perform the interpolation operation on the plurality of first groups of pose data to generate the plurality of second groups of pose data using a spherical linear interpolation technique.

5. The system of claim 1, wherein to register, based on the pose data of the subject, the each group of the plurality of groups of the point-cloud data to form the registered point-cloud data, the at least one processor is configured to cause the system to:
transform, based on the pose data of the subject, the each group of the plurality of groups of the point-cloud data in a first coordinate system associated with the subject into a second coordinate system.

6. The system of claim 5, wherein to transform, based on the pose data of the subject, the each group of the plurality of groups of the point-cloud data from the first coordinate system associated with the subject into the second coordinate system, the at least one processor is configured to cause the system to:
determine, based on the pose data of the subject corresponding to the each group of the plurality of groups of the point-cloud data, one or more transform models; and
transform, based on the one or more transform models, the each group of the plurality of groups of the point-cloud data from the first coordinate system into the second coordinate system.

7. The system of claim 6, wherein the one or more transform models includes at least one of a translation transformation model or a rotation transformation model.

8. The system of claim 1, wherein to generate, based on the registered point-cloud data, a local map associated with the initial position of the subject, the at least one processor is configured to cause the system to:
generate the local map by projecting the registered point-cloud data on a plane in a third coordinate system.

9. The system of claim 8, wherein to generate the local map by projecting the registered point-cloud data on a plane in a third coordinate system, the at least one processor is further configured to cause the system to:
generate a grid in the third coordinate system in which the initial position of the subject is a center, the grid including a plurality of cells; and
generate the local map by mapping feature data in the registered point-cloud data into one or more corresponding cells of the plurality of cells.

10. The system of claim 9, wherein the feature data includes at least one of intensity information or elevation information received by the one or more sensors.

11. The system of claim 9, wherein the at least one processor is further configured to cause the system to:
generate, based on incremental point-cloud data, the local map.

12. The system of claim 11, wherein the at least one processor is further configured to cause the system to:
update, based on feature data in the incremental point-cloud data, at least one portion of the plurality of cells corresponding to the incremental point-cloud data.

13. A method for positioning, comprising:
obtaining point-cloud data acquired by one or more sensors associated with a subject during a time period, the point-cloud data being associated with an initial position of the subject;
dividing the point-cloud data into a plurality of groups;
obtaining pose data of the subject corresponding to each group of the plurality of groups of the point-cloud data;
registering, based on the pose data of the subject, the each group of the plurality of groups of the point-cloud data to form registered point-cloud data; and
generating, based on the registered point-cloud data, a local map associated with the initial position of the subject.

14. The method of claim 13, wherein the each group of the plurality of groups of the point-cloud data corresponds to a time stamp, and the obtaining the pose data of the subject corresponding to the each group of the plurality of groups of the point-cloud data comprises:
determining, based on the time stamp, the pose data of the subject corresponding to the each group of the plurality of groups of the point-cloud data.

15. The method of claim 13, wherein the obtaining the pose data of the subject corresponding to the each group of the plurality of groups of the point-cloud data comprises:
obtaining a plurality of first groups of pose data of the subject during the time period;
performing an interpolation operation on the plurality of first groups of pose data of the subject to generate a plurality of second groups of pose data; and
determining, from the plurality of second groups of pose data, the pose data of the subject corresponding to the each group of the plurality of groups of the point-cloud data.

16. The method of claim 15, wherein the method further comprises:
performing the interpolation operation on the first set of pose data to generate the plurality of second groups of pose data using a spherical linear interpolation technique.

17. The method of claim 13, wherein the registering, based on the pose data of the subject, the each group of the plurality of groups of the point-cloud data to form the registered point-cloud data comprises:
transforming, based on the pose data of the subject, the each group of the plurality of groups of the point-cloud data in a first coordinate system associated with the subject into a second coordinate system.

18. The method of claim 17, wherein the transforming, based on the pose data of the subject, the each group of the plurality of groups of the point-cloud data from the first coordinate system associated with the subject into the second coordinate system comprises:
determining, based on the pose data of the subject corresponding to the each group of the plurality of groups of the point-cloud data, one or more transform models; and
transforming, based on the one or more transform models, the each group of the plurality of groups of the point-cloud data from the first coordinate system into the second coordinate system.

19. (canceled)

20. The method of claim 13, wherein the generating, based on the registered point-cloud data, a local map associated with the initial position of the subject comprises:
generating the local map by projecting the registered point-cloud data on a plane in a third coordinate system.

21-24. (canceled)

25. A non-transitory readable medium, comprising at least one set of instructions for positioning, wherein when executed by at least one processor of an electrical device, the at least one set of instructions directs the at least one processor to perform a method, the method comprising:
obtain point-cloud data acquired by one or more sensors associated with a subject during a time period, the point-cloud data being associated with an initial position of the subject;
divide the point-cloud data into a plurality of groups;
obtain pose data of the subject corresponding to each group of the plurality of groups of the point-cloud data;
register, based on the pose data of the subject, the each group of the plurality of groups of the point-cloud data to form registered point-cloud data; and
generate, based on the registered point-cloud data, a local map associated with the initial position of the subject.

26. (canceled)
